(19) United States
(12) Patent Application Publication
(10) Pub. No.: US 2020/0378130 A1
(43) Pub. Date: Dec. 3, 2020

(54) SHINGLE REMOVING DEVICE

(71) Applicants: BRADLEY D. BULLARD, SHALLOTTE, NC (US); DAVID MILLER, SHALLOTTE, NC (US)

(72) Inventors: BRADLEY D. BULLARD, SHALLOTTE, NC (US); DAVID MILLER, SHALLOTTE, NC (US)

(21) Appl. No.: 16/423,079

(22) Filed: May 27, 2019

(51) Int. Cl. E04D 15/00; B25D 17/02

(52) U.S. Cl. CPC E04D 15/003; B25D 17/02

(57) ABSTRACT

A device for removing shingles having a fork tool and a handle adapted to fit into an air-powered hammer. The fork tool features teeth and has two ends that are joined at an angle. Each tooth has a square-shaped head and a body that extends away from the head of the tooth at an angle. The teeth extend up and away from the fork tool at an angle. The fork tool is removably attached to the handle. In operation, the power tool forces the tool forward under the shingles and the angle of the teeth lifts the shingles slightly off the surface of the roof and the leading edge and the trailing edge of the fork tool forces the shingle upward. The device features a back plate also attached to the handle that has a ridge along its lateral surface that can be used as a fulcrum.

### BACKGROUND OF THE INVENTION

### (a) Field of the Invention

The present invention is in the technical field of roofing tools. More particularly, the present invention is in the technical field of shingle removal tools.

### (b) Background Art

A leak-proof roof is one of the best investments a homeowner can make in their home. While often taken for granted, the roof of a residence is there to protect both the occupants and the rest of the home from the weather. Roof maintenance is vital to preservation of home value.

Replacing an existing roof necessarily involves some special tools. In the end, the components of a roof system, including shingles, felt-paper, waterproof underlayment and the like are all attached to a roof using nails and adhesives. As a result, the tools used to remove these items have to be inserted underneath the layers of shingles and other materials and are used to pry the materials loose from the roof surface before being discarded. Typically for this type of work, roofers will use a number of devices that are variations on the classic crowbar tool. Some devices consist of what is essentially a shovel with a serrated edge meant to be inserted under the edge of a shingle (see U.S. Pat. No. 8,079,290 issued to Daniel Cox). In use, the roofer slides the serrated edge of the device under the edge of one or more shingles, applies enough force to drive the edge of the device completely underneath the shingle, and then pries or lifts the back portion or handle of the device to pry the shingle and its nails loose from the surface of the roof. Other roofers prefer a pitchfork style tool that catches less of the nails and thus can be easier or quicker to use to remove the shingles. These devices do an imperfect job of removing all of the nails from the roof surface. In addition, they require manual force to be applied by the roofer and thus can be difficult to use effectively for long periods of time.

The patent literature contains a number of different devices meant to improve upon the traditional tools used to remove shingles from a roof. For example, U.S. Pat. No. 3,987,827 issued to William Mills describes a z-shaped crowbar with a wedge-shaped head featuring a forward facing claw, rear facing notches and laterally projecting arms. In use the claw is forced under a shingle, then force is applied to pry the shingle upward allowing the arms to be inserted under the free end of the shingle as the device is forced forward. The arms are meant to hold the shingle up as the tool is inserted further underneath the shingle. The claw can be inserted under a nail head as can the rearward facing notches allowing the tool to remove a nail regardless of which direction the tool is being pushed.

U.S. Pat. No. 4,858,503 issued to John H. Dike, Jr. describes a device that automates the lifting of the shingle. The device includes a wedge-shaped lift plate that pivots around a fulcrum through the use of pneumatic motor or piston thereby lifting the shingle once it is manually placed under the shingle by the roofer. However, the forward force required to insert the device under the shingle is provided by the user, not the device itself—the device merely lifts a shingle once the user inserts the device under said shingle. In addition, the wedge-shaped lift plate is more difficult to insert under the shingle than the flattened head of other devices described above.

The above devices suffer from a handful of common problems. First, all of these devices require the operator to manually insert a blade or plate under the shingle to be removed. Doing so is a large portion of the work involved in removing the shingle to begin with as inserting the device under the shingle necessarily involves breaking the contact between the roof and the shingle. In addition, the force required to insert the device underneath a shingle presents a certain amount of danger to a person working on an angled surface above the ground. As dictated by Newton's Second Law of Motion, the force that the operator exerts to move the device forward and underneath a shingle equals the force applied to the operator in the opposite direction; a situation that can be dangerous for someone working near the edge of a roof. Not only that, but people are prone to fatigue and their ability to continually applying the forward force necessary to use the above described tools will cause them to tire and be less effective over time. Moreover, the amount of force applied manually will vary from one operator to the next. Last, but not least, the force applied by a person has a downward vector that puts additional pressure on the rest of the roof surface leading the possibility of damage to the roof.

It is an object of the present invention to provide a shingle removing device that automates the insertion of the device underneath a shingle that has been attached to a surface without relying on manual force generated by a user, thereby eliminating or reducing the problems detailed above. Another object of the present invention is to provide a shingle removal tool that pries the shingle loose from the surface to which it is attached without force being applied by the operator of the device. It is another object of the invention to provide a shingle removing device that reduces the amount of strain experienced by the operator of the device. In addition, it is an object of the present invention to provide a shingle removing device that is capable of applying a uniform amount of pressure on the existing and remaining roof structure when removing shingles and related materials. It is a further object of the disclosed invention to provide an automated shingle removing device that can be used with existing devices rather than requiring a separate motor to be provided with the device. These and other advantages will become apparent from the following disclosure.

### BRIEF SUMMARY OF THE INVENTION

This disclosure pertains to a novel device for removing shingles from a roof. The disclosed device could also be used in other contexts, for example to remove floor tile or other flattened materials, but preferred embodiments and the anticipated best mode of the device are adapted specifically to remove shingles from the surface of a roof.

Generally, preferred embodiments of the shingle removing device feature a handle and a fork tool. The handle is adapted, i.e., sized and shaped to fit into an air-powered hammer in place of the standard drill bit that would be installed in such a device. Alternately, the device can be used with similar devices such as pneumatic hammers, electric hammers, jack hammers and the like.

The end of the device that is opposite the handle features a fork tool. The fork tool is an elongated structure that features cutouts, tines, teeth, protrusions, or similar structures (henceforth referred to as “teeth”). These teeth are separated by grooves. The teeth and grooves are shaped to allow the device to encircle and grip nails that are holding the shingles onto the roof. In preferred embodiments of the device, each tooth is has a square-shaped head and a body that extends away from the head of the tooth at an angle, i.e. each side wall of each tooth flares out on each side to form a trapezoid-like shape. The top edge of the teeth, the edge furthest away from the handle, is blunted, rounded or flat. In addition, as the sides of each tooth angle out and downward away from the blunt edge of the tooth they meet a trough on either side of the tooth. The sides of two teeth come together at the base of the trough. Some embodiments have been found to work best when the base of the trough forms an angle between 23 and 24 degrees with the sides of the two adjacent teeth. The anticipated best mode of the fork tool features a flattened trough between each of the teeth such that the angle between the trough and the two side walls is 23.78 degrees.

Various embodiments can have as much or little space between the teeth as desired, but the inventor has found that the width of the groove between teeth at its lowest point or trough is ideally approximately 0.04 inches wide with the blunt edge of the teeth being over five times wider or 0.21 inches in width. Various embodiments feature teeth that are three quarters (0.75) of an inch in total length. While preferred embodiments of the device have teeth that are uniformly sized and spaced apart, other embodiments can vary the dimensions of the teeth from one tooth to another having some teeth that are closer together, wider and/or taller than other teeth on the same fork tool. In addition, the teeth on each end of the fork tool need not have an angled side wall when that side wall is at either of the ends of the fork tool as there is no tooth on at least one side of those end teeth.

Preferred embodiments of the fork tool are made from a 12 gauge steel sheets or plates made of A514 steel that is approximately 0.10 inches thick. In this disclosure, the A514 steel is defined in the manner defined by the American Society for Testing Materials or ASTM. The gauge of the steel is that currently defined by 15 U.S.C. § 206.

The fork tool is necessarily connected to the handle, but the means to do so can vary from one embodiment to another. For example, the fork tool can have a leading edge featuring the teeth and grooves and a second or trailing edge that is used to connect the fork tool to the rest of the device. In some preferred embodiments, the trailing edge of the fork tool extends away from the leading edge of the fork tool at an angle. This angled shape allows the user to insert the tool under a shingle and then pry the shingle loose from the roof simply by pushing the device forward, i.e. without applying a prying motion or force to the device to dislodge the shingle from the roof. Preferred embodiments and the anticipated best mode of the device have a leading edge that extends away from the trailing edge at an angle of approximately twenty-two (22) degrees. “Approximately” in this disclosure means within 1.0 degree of the specified number. Furthermore, the teeth on the leading edge do not have to extend straight out from the surface of the leading edge of the fork tool. Rather, the inventor has found the device works better if the teeth taper to a narrower point as they extend away from the leading edge of the fork tool. Preferred embodiments and the anticipated best mode of the fork tool have teeth that extend up and away from the leading edge of the fork tool at an angle between 11 and 12 degrees. That is to say, as the teeth extend away from the bottommost surface of the fork tool, they become thinner, thus creating an angle between the bottom of the teeth and the surface along which the fork tool slides or the plane in which the leading edge of the fork tool sits. In this disclosure the term “up” when used in reference to the invention means away from the back surface of the device. The back surface of the device is the surface that faces toward the roof that is being deshingled. The upward angling of the teeth helps to ensure that the tool contacts the underside of the shingle more than it contacts the roof surface itself. Such a design makes it easier to slide the tool across the surface of the roof without damaging the roof with the teeth of the fork tool.

Preferred embodiments of the device include a plate, referred to as a tool handle plate, attached to the handle. In preferred embodiments and the inventor's anticipated best mode of the device, the tool handle plate is welded or otherwise permanently attached to the handle. The trailing edge of the fork tool features attachment means to attach the device to the tool handle plate. The attachment means can consist of any conventional fasteners inserted through holes. In preferred embodiments, the attachment means include square shaped, dimple recess holes meant to accommodate a carriage bolt, ideally a 5/16″-18 carriage bolt which is a 5/16 inch bolt with a rounded head and a square shaped shoulder that inserts into the hole. The shaped of the hole and the shoulder together prevent the bolt from turning after the bolt is fully inserted.

In some embodiments, the fork tool and handle can be made as one integrated piece. However, it is more desirable to make the device such that the fork tool can be removed from the rest of the device so the user can replace or repair the fork tool if need be. To make construction and production simpler, preferred embodiments of the shingle removing device feature a handle with a back plate and means to attach the back plate to the handle. These embodiments of the device feature a back plate with two sets of holes. One set of holes is meant to attach the plate to the handle itself. The second set of holes is meant to connect the fork tool and the back plate to the handle. Preferred embodiments of the tool handle plate have the same attachment means featured by the fork tool. In the inventor's anticipated best mode of the device, these attachment means are dimple recess holes configured to accommodate a carriage bolt, ideally a carriage bolt with a square shaped shoulder as discussed above.

In use, the fork tool is attached to the tool handle plate and a back plate is then attached to the tool handle plate. The back plate features a ridge that runs laterally along the surface of the back plate or in some embodiments, one of the edges of the back plate terminates in a ridge. The ridge extends out and away from the plane in which the rest of the back plate is positioned. The ridge runs along the entire lateral length of one surface of the back plate from one side edge of the back plate to an opposing side edge. This ridge can be used as a fulcrum to help apply a prying pressure to the fork tool if needed.

In use, the operator assembles the device by attaching the fork tool to one side of the tool handle plate and the back plate to the other side of the tool handle plate. The operator then inserts the handle of the device into the appropriate power tool or air hammer. In operation, the power tool forces the tool forward and backward (towards and away from the user) in a reciprocating movement. The operator need only position the teeth of the fork tool at the edge of the shingles to be removed and then activate the power tool. In operation, the power tool forces the fork tool under the shingles. As the fork tool is inserted under the shingles, the angle of the teeth lifts the shingles slightly off the surface of the roof. As the fork tool inserts further under the shingles, the angle between the leading edge and the trailing edge of the fork tool forces the shingle upward. If the operator needs additional leverage to pry the shingle loose, then the operator can take advantage of the ridge on the back plate by using it as a fulcrum to apply a prying force to the shingle.

### BRIEF DESCRIPTION OF THE SEVERAL VIEWS OF THE DRAWINGS

FIG. 1 is an exploded view of a preferred embodiment of the roofing tool;

FIG. 2 is a plan view of a preferred embodiment of the fork tool;

FIG. 2a is a plan view of a portion of the fork tool shown in FIG. 2;

FIG. 2b is a side plan view of one of the teeth of the fork tool shown in FIG. 2;

FIG. 3a is an elevated plan view of the back plate; and

FIG. 3b is a side view of the same back plate.

### DETAILED DESCRIPTION OF THE INVENTION

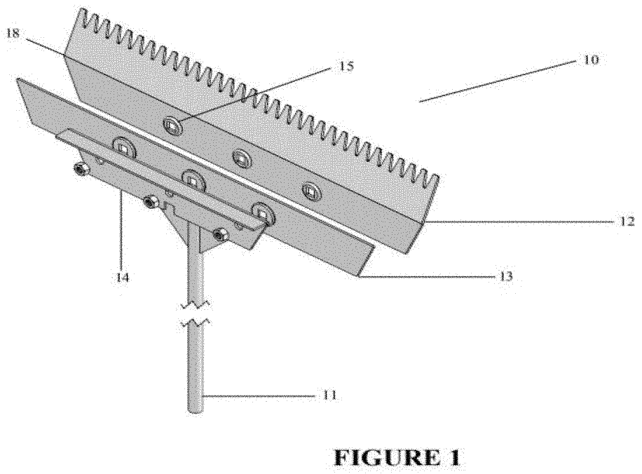

FIG. 1 shows an exploded view of a preferred embodiment of the roofing tool 10 that demonstrates all of the features previously discussed. A skilled artisan will realize upon reading this disclosure that the roofing tool 10 has a number of features that are optional, but tend to be preferred by the inventor. In its most basic form, the roofing tool 10 includes a handle 11 that is adapted to be inserted into a power tool (not shown), such as an automatic hammer, and a fork tool 12. The embodiment described in the figures is a preferred embodiment with additional features that reflect the best mode of the device that the inventor has devised.

The embodiment of the roofing tool 10 shown in FIGS. 1-3b includes a fork tool 12, a tool handle plate 13, a back plate 14 and a handle 11. As previously discussed, in the anticipated best mode of this device, the tool handle plate 13 is permanently fixed to the handle 11 via conventional means, either through fasteners or by welding one part to the other. The tool handle plate has attachment means 15 to allow for the attachment of the fork tool 12 and the back plate 14, as desired.

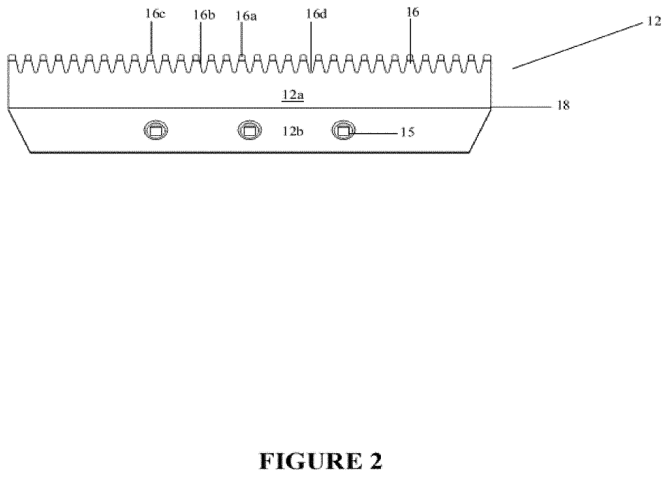

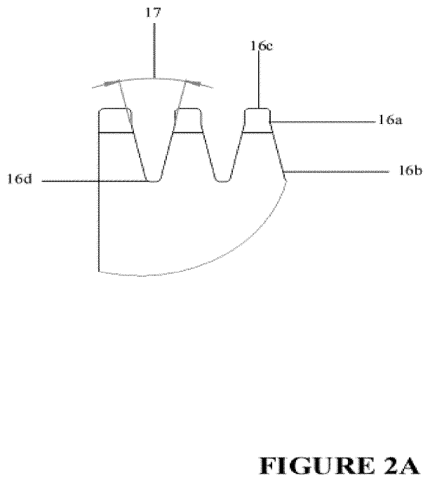

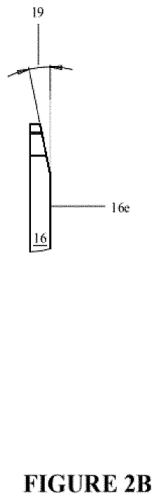

The details of the fork tool 12 are more easily explained with reference to FIG. 2 which shows the fork tool 12 in isolation and a close up of the teeth 16 of the fork tool 12, respectively. This version of the fork tool 12 includes a plurality of teeth 16, separated by spaces referred to as troughs 16d. Preferred embodiments of the teeth 16 include a square-shaped head 16a and sides 16b that extend outward away from the head 16a at an angle. The sides 16b of the teeth 16 come together to form the trough 16d separating the teeth 16. FIG. 2A shows the sides 16b and trough 16d form an angle 17 of 23.78 degrees with each other. Ideally, the trough 16d is approximately 0.04 inches wide. In this disclosure, an approximate distance is within 10% of the stated distance. For example, approximately 0.04 inches means within 0.004 inches of 0.04 inches. Furthermore, the width of the head of the teeth 16 is approximately 0.21 inches and the teeth 16 are approximately 0.36 inches apart at their apex 16c. The fork tool has a leading edge 12a and a trailing edge 12b. The leading edge 12a is the end of the fork tool 12 that is first inserted underneath shingles that need to be removed. The trailing edge 12b of the fork tool is the portion of the fork tool 12 that contains attachment means 15 for attaching the fork tool 12 to other portions of the roofing tool 10. As discussed above, the leading edge 12a of the fork tool 12 extends away from the trailing edge 12b at an angle 18 (best seen in FIG. 1). In this embodiment, the angle is approximately 22 degrees. This angled shape allows the user to insert the fork tool 12 under a shingle and then pry the shingle loose from the roof simply by pushing the roofing tool 10 forward, i.e. without applying a prying motion or force to the device to dislodge the shingle from the roof.

FIG. 2B shows a close up of the teeth 16 of the fork tool 12 shown in profile. In this version of the fork tool 12, the teeth 16 taper or become thinner as seen in profile as they extend away from the rest of the fork tool 12. This tapering means that there is an angle 19 formed between the plane in which the leading edge of the fork tool 12 is positioned (or the roof) and the bottom surface 16e of each tooth 16. Angle 19 is approximately 11.85 degrees. The space formed between the bottom of the fork tool 12 and the surface along which it is slid or moved helps to ensure that the fork tool 12 contacts the underside of the shingle more than it contacts the roof surface itself.

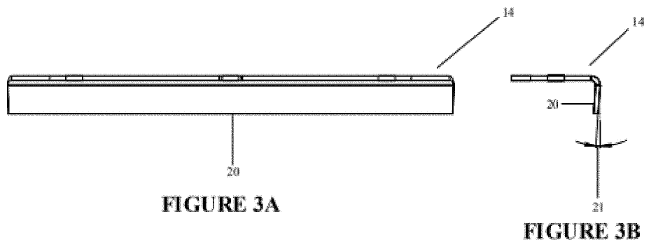

FIGS. 3A and 3B show the back plate 14 in isolation and more detail. The back plate 14 is a purely optional feature of the roofing tool 10 that provides additional strength and structural support to the roofing tool 10. This embodiment of the back plate 14 features a ridge 20 extending along a surface of the back plate 14—the surface that is opposite the surface that attaches to the rest of the roofing tool 10. The ridge 20 extends horizontally (perpendicular to the longitudinal axis of the handle) from one side of the back plate 14 to the other. Alternately, the back plate 14 could feature a ridge 20 that does not extend across the entire lateral width of the back plate 14, but rather extends across a portion of the surface of the back plate 14. The ridge 20 extends out and away from the plane in which the rest of the back plate 14 is located. The ridge 20 runs along the entire lateral length of one surface of the back plate from one side edge of the back plate to an opposing side edge. This ridge 20 can be used as a fulcrum to help apply a prying pressure to the fork tool if needed. The operator simply pulls or pushes downward on the end of the handle 11 that is opposite the fork tool (or the power tool to which it is attached) while the ridge is resting against a surface, such as the roof, and thereby forces the fork tool 12 up and away from the same surface. FIG. 3B also shows the back plate 14 in profile. Note in some embodiments, the angle 21 between the ridge 20 and the back plate 14 is a right angle, but in this embodiment, the angle 21 is approximate 86 degrees rather than 90 degrees.

To explain the assembly of the device, reference will be made to FIG. 1. In preferred embodiments, the tool handle plate 13 is permanently attached to the handle 11 via welding. However, a skilled artisan would readily appreciate any attachment means, permanent or temporary, could be used to attach the tool handle plate 13 to the handle 11. The tool handle plate 13 includes attachment means to allow the fork tool 12 and the back plate 14 to be attached to the tool handle plate 13. In alternate embodiments, the fork tool 12 can be attached directly to, or made as an integrated unit with the handle 11. In preferred embodiments, square-shaped, dimpled recess holes ## are featured in the surfaces of the fork tool 12, back plate 14 and/or tool handle plate 13 to allow for the insertion of a 5/16″-18 carriage bolt having a square-shaped shoulder and a rounded head.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A device for removing shingles comprising a handle that is configured to be inserted into an air-powered hammer.

2. The device of claim 1 further comprising a fork tool having a plurality of teeth.

3. The device of claim 2 wherein a first part of the fork tool extends away from a second part of the fork tool at an angle.

4. The device of claim 3 wherein the angle between the first part of the fork tool and the second part of the fork tool is 22 degrees.

5. The device of claim 4 wherein the teeth extend away from the fork tool at an angle to a plane of the fork tool.

6. The device of claim 5 wherein the angle at which the teeth of the fork tool extend away from the plane of the fork tool is between 11 and 12 degrees.

7. The device of claim 2 wherein each of the plurality of teeth have a body with two side walls and a square-shaped head.

8. The device of claim 3 wherein each of the plurality of teeth have a body with two side walls and a square-shaped head.

9. The device of claim 4 wherein each of the plurality of teeth have a body with two side walls and a square-shaped head.

10. The device of claim 7 wherein each of the plurality of teeth are separated by a trough and the angle between the trough and the side walls of the adjacent teeth is between 23 and 24 degrees.

11. The device of claim 8 wherein each of the plurality of teeth are separated by a trough and the angle between the trough and the side walls of the adjacent teeth is between 23 and 24 degrees.

12. The device of claim 9 wherein each of the plurality of teeth are separated by a trough and the angle between the trough and the side walls of the adjacent teeth is between 23 and 24 degrees.

13. The device of claim 2 further comprising a back plate featuring a ridge extending from one side edge of the back plate to the other side edge of the back plate.

14. The device of claim 4 further comprising a back plate featuring a ridge extending from one side edge of the back plate to the other side edge of the back plate.

15. The device of claim 6 further comprising a back plate featuring a ridge extending from one side edge of the back plate to the other side edge of the back plate.

16. A device comprising:
a handle configured to be inserted into an air-hammer;
a fork tool attached to the handle, wherein the fork tool features a plurality of cutouts that form teeth separated by troughs; and
a back plate with a ridge extending from one side of the back plate to the opposing side of the back plate.

17. The device of claim 16 wherein the fork tool has a leading edge and a trailing edge that are joined at an angle of approximately 22 degrees.

18. The device of claim 16 wherein the teeth extend away from the fork tool at an angle of 11.85 degrees to a plane of the fork tool

19. The device of claim 17 wherein the teeth extend away from the fork tool at an angle of 11.85 degrees to a plane of the fork tool

20. The device of claim 16 wherein the ridge extends away from the back plate at an acute angle.
